(19) United States
(12) Patent Application Publication
(10) Pub. No.: US 2007/0153727 A1
(43) Pub. Date: Jul. 5, 2007

(54) In-band multi-user scheduling information transmission for group services

(76) Inventors: Sean M. McBeath, Keller, TX (US); Mansoor Ahmed, Fort Worth, TX (US); Zhijun Cai, Euless, TX (US); James M. O'Connor, Dallas, TX (US)

Correspondence Address: LAW OFFICES OF CHARLES W. BETHARDS, LLP, P.O. BOX 1622, COLLEYVILLE, TX, 76034, US

(21) Appl. No.: 11/323,410

(22) Filed: Dec. 30, 2005

(51) Int. Cl. H04Q 7/00

(52) U.S. Cl. 370/329

(57) ABSTRACT

Methods (440, 500, 600) and corresponding systems (20, 24, 190) for scheduling uplink resources for communication with a base station (22) include receiving an uplink resource request (82, 204) for an uplink channel resource for a subscriber station (24). In response to the uplink resource request (82), generating an uplink resource grant message (206) for scheduling a selected uplink channel resource for the subscriber station (24); and inserting the uplink resource grant message into a shared traffic packet (158, 208) for transmission from the base station (22) on a shared traffic channel (56).

### FIELD OF THE INVENTION

This invention relates in general to data communication, and more specifically to techniques and apparatus for requesting and granting the scheduling of communication resources in a data communications system.

### BACKGROUND OF THE INVENTION

Video games have increased in popularity and sophistication since the release of Pong® by Atari, Inc. in 1972. Video games are now prevalent on gaming consoles, computers, MP3 players, personal digital assistants, and cell phones. As games developed, multi-player games, wherein game players interact with one another, have increased in popularity. However, because of the frequent time-critical messages that are required to control game play, multi-player games are mainly computer based, and not yet available on cell phones and other wireless devices.

In a “push-to-game” service, multiple users can be active simultaneously, which is fundamentally different from a push-to-talk service where dedicated uplink and downlink control channels are used by each subscriber station to intermittently and infrequently request an uplink traffic channel resource, and subsequently receive a grant of an uplink traffic channel resource, such as a scheduled time slot and a frequency, that the subscriber station will use for an upcoming uplink transmission. This media access control procedure may be known as a request/grant procedure. In the request/grant procedure, a pair of uplink and downlink control channels are dedicated to each subscriber station to transmit the resource request/grant messages. This is similar to the method used in the Enhanced Uplink Packet Access of an Enhanced Universal Mobile Telecommunications System (E-UMTS).

In contrast, the traffic in services like real-time gaming or instant messaging is nearly constant-rate, with an on/off model, where in the “on” state, data is transmitted at a designated data rate, and in the “off” state, data is not transmitted. This constant requirement for uplink channel resources consumes control channel resources that should be reserved for fast request/grant operation for push-to-talk services.

### BRIEF DESCRIPTION OF THE DRAWINGS

The accompanying figures, wherein like reference numerals refer to identical or functionally similar elements throughout the separate views and which together with the detailed description below are incorporated in and form part of the specification, serve to further illustrate various embodiments and to explain various principles and advantages, all in accordance with the present invention.

FIG. 1 depicts, in a simplified and representative form, a high-level diagram of a communications system in accordance with one or more embodiments;

FIG. 2 shows, in a representative form, a high-level schematic diagram of portions of a subscriber station in accordance with one or more embodiments;

FIG. 3 depicts a high-level representative diagram of portions of a base station and portions of a communications network infrastructure in accordance with one or more embodiments;

FIG. 4 shows a high-level flowchart of processes executed by a communication system that can be used in conjunction with the system of FIGS. 1 and 3 in accordance with one or more embodiments;

FIGS. 5 and 6 depict high-level flowcharts of processes executed by a communication system that can be used in conjunction with the system of FIGS. 1 and 2 in accordance with one or more embodiments;

FIG. 7 shows, in a representative form, a resource request message field in accordance with one or more embodiments;

FIG. 8 shows, in a representative form, a resource grant message field in accordance with one or more embodiments;

FIG. 9 shows, in a representative form, a stream of packets transmitted in a shared traffic channel in accordance with one or more embodiments; and

FIG. 10 shows, in a representative form, an uplink channel resource scheduling chart in accordance with one or more embodiments.

### DETAILED DESCRIPTION

In overview, the present disclosure concerns a scheduling system for scheduling uplink channel resources in a communication system, and more specifically techniques and apparatus for subscriber stations to efficiently request uplink channel resources from a base station and to receive scheduling information in a communications resource grant message. More particularly various inventive concepts and principles embodied in methods and apparatus may be used for transferring in-band multi-user media access control information for scheduling communication resources for group services in a communications system.

While the scheduling system of particular interest may vary widely, one embodiment includes a wireless cellular communications system having application servers in, or connected to, a communications network infrastructure. However, the inventive concepts and principles taught herein may be advantageously applied to other broadband communications systems having multiplexed communication links including, e.g., those that are not wireless.

The instant disclosure is provided to further explain in an enabling fashion the best modes, at the time of the application, of making and using various embodiments in accordance with the present invention. The disclosure is further offered to enhance an understanding and appreciation for the inventive principles and advantages thereof, rather than to limit in any manner the invention. The invention is defined solely by the appended claims, including any amendments made during the pendency of this application, and all equivalents of those claims as issued.

It is further understood that the use of relational terms, if any, such as first and second, top and bottom, and the like, are used solely to distinguish one entity or action from another without necessarily requiring or implying any actual such relationship or order between such entities or actions.

Much of the inventive functionality and many of the inventive principles are best implemented with, or in, integrated circuits (ICs), including possibly application specific ICs, or ICs with integrated processing controlled by embedded software or firmware. It is expected that one of ordinary skill—notwithstanding possibly significant effort and many design choices motivated by, for example, available time, current technology, and economic considerations—when guided by the concepts and principles disclosed herein will be readily capable of generating such software instructions and programs and ICs with minimal experimentation. Therefore, in the interest of brevity and minimization of any risk of obscuring the principles and concepts according to the present invention, further discussion of such software and ICs, if any, will be limited to the essentials with respect to the principles and concepts of the various embodiments.

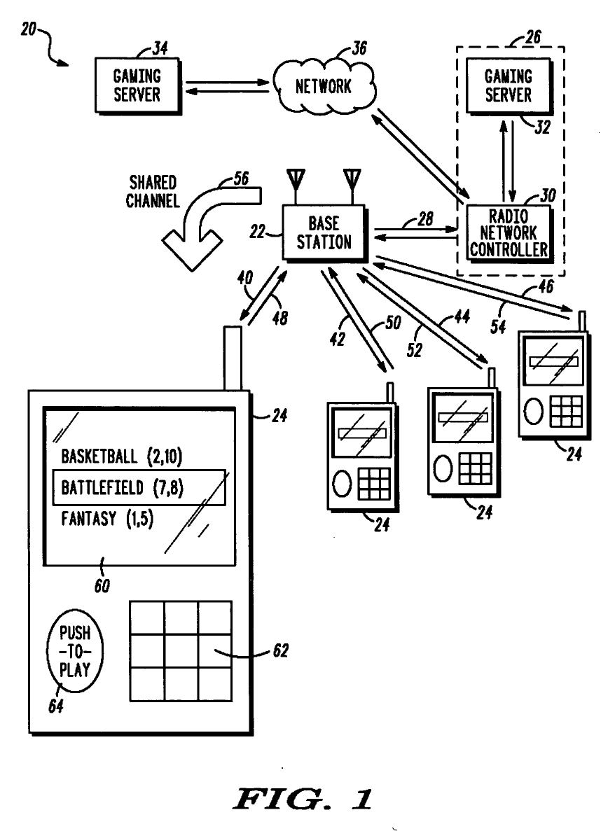

Referring to FIG. 1, a simplified and representative high-level diagram of a portion of a communications system in accordance with one or more embodiments will be briefly discussed and described. In FIG. 1, communications system 20 includes one or more base stations 22 in communication with one or more subscriber stations 24. Base station 22 is typically connected to communications network infrastructure 26 by communication link 28.

Communications network infrastructure 26 typically includes radio network controller 30, which controls various aspects of base station 22 operation, including handoffs of subscriber stations 24 to alternate base stations 22. Alternatively, the function of radio network controller, or portions thereof, can be merged into base station 22, such as in an Enhanced Universal Mobile Telecommunications System (E-UMTS). Communications network infrastructure 26 can also include servers for providing various network services, or group services, such as games. These group services or games can be hosted by, for example, gaming server 32. Other services can be provided by a remote server, such as remote gaming server 34, which is connected to communications infrastructure 26 by network 36.

In some modes of operation, subscriber station 24 communicates with base station 22 using downlink 40 and uplink 48. Downlink 40 carries data traffic or commands from base station 22 to subscriber station 24. As shown, each subscriber unit 24 uses a different downlink 40-46, wherein each is assigned a different communication resource so that communication channels allocated to subscriber stations 24 are separated, or multiplexed. Such communication resources can be a frequency, a time slot, a spreading code, or other similar communication resources used in multiplexing or separating communication channels. Subscriber stations can also be allocated more than one downlink, where one can be used for data traffic and another can be used for control messages. Allocating more than one downlink consumes more communication resources.

Similarly, uplink 48 carries data traffic or commands from subscriber station 24 to base station 22. Each subscriber station 24 uses a separate uplink 48-54, wherein each is assigned different uplink channel resources for multiplexing the uplink communication channels. Subscriber stations can also be allocated more than one uplink.

Subscriber stations 24 can be used to play games using the resources of communications system 20, including the resources of servers 32 or 34 that can host game applications. Some games are single-user games that are played by one person. Other games are multi-user games. Multi-user games allow users of a plurality of subscriber stations 24 to play a game together, wherein the users interact in a game environment and play cooperatively or competitively. Display 60 on subscriber unit 24 can be used to display the game environment, and keypad 62 and input device 64 can be used to receive commands and game action input from the user. Input device 64 can be a dedicated button that the user presses to request a menu of games that are available or hosted by communications system 20. Alternatively, input device 64 can include a joystick, or other ergonomic input device, or pointing device. A menu for selecting an available game is shown on display 60 in FIG. 1.

When communications system 20 is used to play a multi-user game, there can be common data traffic that is sent to each of the subscriber stations 24. When common traffic data is sent to multiple subscriber stations 24, base station 22 can use shared channel 56 to broadcast, or multicast, shared data contained in shared traffic packets to a plurality of subscriber stations 24 that are playing the game.

An example of shared data channel 56 is a so called “multimedia broadcast” or “multicast service,” which is more completely described in the specification entitled “TS 25.346, Introduction of Multimedia Broadcast/Multicast Service (MBMS) In the Radio Access Network (RAN),” published by the 3rd Generation Partnership Project (3GPP). The game data that is transmitted using shared channel 56 can include data that describes the game environment, or the other user's movements or actions in the game, wherein such data is used to create the common game experience. Using shared channel 56 conserves communication resources at base station 22 because much of the same game data is not repeatedly transmitted via downlinks 40-46, which are each dedicated to a specific subscriber station.

As users play the game, and input game instructions or actions using input device 64 and keypad 62, uplink traffic from subscriber units 24 is generated, which creates a need for uplink channel resources to communicate such input data to gaming server 32 or 34. Access to uplink channel 48 is typically based upon a request by a subscriber station 24, and granted by a response from base station 22, which response includes scheduling information used by the subscriber station for subsequently transmitting an uplink traffic channel packet.

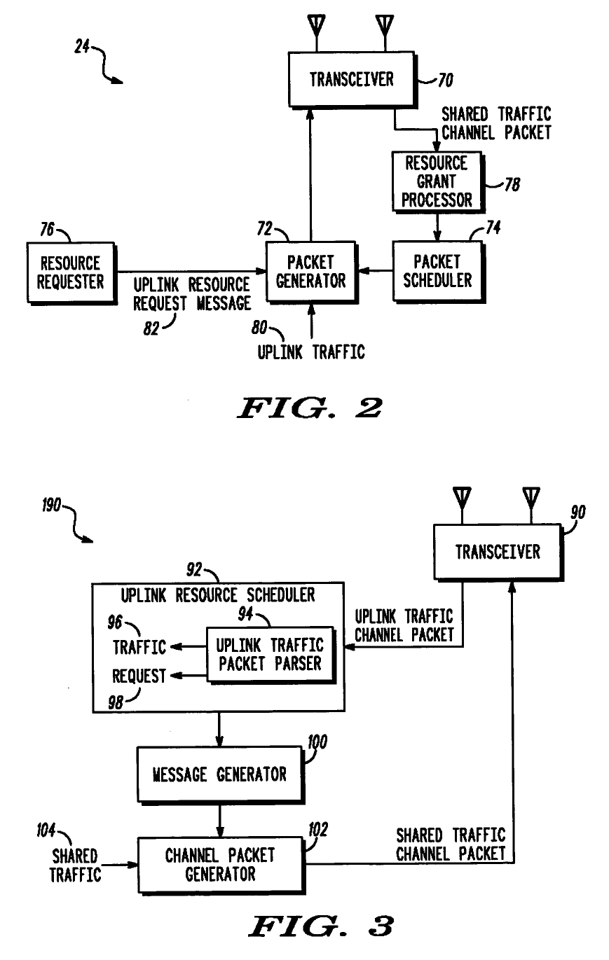

Referring to FIG. 2, there is depicted a representative diagram of a portion of subscriber station 24 of FIG. 1 that illustrates functional blocks for scheduling and transmitting uplink traffic packets in accordance with one or more embodiments. As shown, subscriber station 24 includes transceiver 70, which transmits data and receives data via a transmission medium. In one embodiment, transceiver 70 is a wireless transceiver for wirelessly transmitting and receiving data, such as the wireless transceivers that can be used to implement a cellular network. In other embodiments, transceiver 70 can be a transceiver used in a different multiplexed broadband medium, such as a cable system transceiver or a fiber optic system transceiver. Inputs to transceiver 70, and outputs from transceiver 70, are baseband data.

Transceiver 70 is coupled to packet generator 72 for receiving and preparing data for transmission to base station 22 in an uplink traffic channel packet. Packet generator 72 is coupled to packet scheduler 74, which sends control signals that specify the communication resources used by packet generator 72 and transceiver 70 when transmitting an uplink traffic packet. Such communication resources are assigned in a grant message from base station 22 that determines how and when subscriber station 24 will transmit data. Such granted communication resources can include a time slot, a frequency, a sub-channel, a spreading code, a quality of service level, or another similar parameter that is specified in the particular protocol used to transmit an uplink traffic packet.

Resource grant processor 78, which is coupled to transceiver 70 and packet scheduler 74, is used to receive a resource grant message and to process data in that message that is specifically related to the scheduling of uplink packets from that subscriber station 24. Such processed scheduling data is then passed to packet scheduler 74.

Packet generator 72 also has inputs for receiving uplink traffic data 80 and an uplink resource request message 82, which message is generated by a resource requester 76. Packet generator 72 receives uplink traffic 80 and the uplink resource request message 82 and generates an uplink traffic packet containing both types of data. The uplink traffic packet is then sent to transceiver 70 for a scheduled uplink transmission.

With reference now to FIG. 3, there is depicted a more detailed representative diagram of portions of a base station and an associated communications network (collectively referenced as 190) in accordance with one or more embodiments. As illustrated in FIG. 3, portions of base station 22 and communications network 26 (see FIG. 1) include transceiver 90 for transmitting and receiving data traffic and control data with subscriber stations 24 (see FIG. 1). As mentioned above with respect to transceiver 70, transceiver 90 can be a wireless type used in a cellular communications network, or alternatively a type used for transmitting and receiving in another broadband media.

Transceiver 90 is coupled to uplink resource scheduler 92, which processes uplink traffic packets from subscriber stations 24. Uplink resource scheduler 92 is used to receive uplink resource requests, such as uplink resource request message 82 from subscriber stations 24, and to schedule uplink transmissions from the requesting subscriber stations. Uplink transmissions can be scheduled according to various criteria, such as available communication resources, previous requests for uplink resources, quality of service guarantees, priorities among the subscriber stations, and other similar scheduling considerations.

In some embodiments, uplink resource requests may be generated periodically and automatically by a function with uplink resource scheduler 92 so that the system provides each subscriber a periodic opportunity to send an uplink traffic packet. This function is similar to a polling function.

Uplink resource scheduler 92 can include uplink traffic packet parser 94, which parses or separates uplink traffic data from uplink resource request data, both of which are contained in an uplink traffic channel packet. Uplink traffic packet parser 94 recognizes uplink resource requests included in the traffic packet and separates and outputs both request message 98 and traffic data 96.

Uplink resource scheduler 92 is coupled to message generator 100, which generates an uplink resource grant message in response to scheduling data developed by uplink resource scheduler 92, which data describes the scheduled use of uplink channel resources. The resource grant message will be used to instruct one or more subscriber stations 24 how and when to send an uplink traffic packet to base station 22.

Message generator 100 is coupled to channel packet generator 102. The function of channel packet generator 102 is to combine shared traffic data 104 with a grant message from message generator 100 to generate a shared traffic channel packet. Shared traffic data 104 is data that will be sent simultaneously to one or more subscriber stations 24 on a shared channel (such as shared channel 56 in FIG. 1), which shared channel does not use downlink communication channel resources individually dedicated to each subscriber station 24. In one embodiment, the shared data is data that is related to playing a multi-user game.

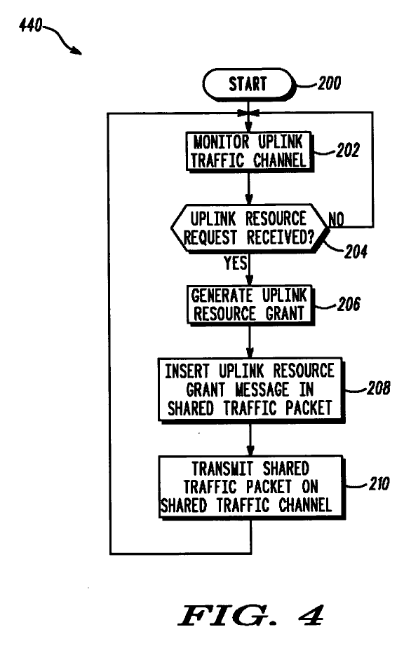

Referring now to FIG. 4, there is depicted a high-level flowchart 440 of exemplary processes executed by portions of a base station, or communications network infrastructure, which are shown in the system of FIGS. 1 and 2, in accordance with one or more embodiments. As illustrated, the process begins at block 200, and thereafter passes to block 202 wherein the process monitors one or more uplink traffic channels for a request for an uplink channel resource. Note that the uplink resource request will be contained in an uplink traffic packet from the requesting subscriber station, rather than being received on a dedicated control channel from the requesting subscriber station. Such an uplink media access control request message may be referred to as an “in-band” message because it is inserted into a packet that also carries data traffic. In one embodiment, this monitoring process can be implemented in uplink resource scheduler 92, as shown in FIG. 3. More specifically, the monitoring process of block 202 can be implemented using an uplink traffic packet parser 94, which parses or separates traffic data 96 from uplink resource requests 98.

An example of an uplink resource request message is shown in FIG. 7. Resource request message 112 can include a requested resource status (RSS) field 114, which can be used to identify a status of any requests contained in message fields that follow. For example, if this field contains two bits, a “00” status can indicate that no resource request follows. A “01” status can indicate that the current requested resource is the same as a previously requested resource, and that there may or may not be specific request information in following fields. Note that if a “same request” status is indicated, and specific request information is provided in a following field, the request will be considered a repeated request. An “11” status can indicate that the currently requested resource is different from a previously requested resource, and that there is specific request information in following message fields. A “10” status can be reserved for future use.

Required resource description field 116 is an optional field used to describe the requested communication resource. For example, data in this field can describe a number of time slots required, a number of resource elements (e.g., sub-carriers, Walsh codes, or the like) required, or an amount of data that needs to be transmitted (e.g., a transport box size, or the like).

Quality of service (QoS) profile field 118 can be used to identify a requested QoS level, which can, for example, include a maximum tolerated delay, an average tolerated delay, a bit error rate, and other similar parameters. This data can be used by uplink resource scheduler 92 to schedule uplink channel resources.

Next in the process of FIG. 4, the process determines whether or not an uplink resource request has been received, as depicted at block 204. If an uplink resource request has not been received, the process iteratively returns to block 202 to continue monitoring. If an uplink resource request has been received, the process passes to block 206, wherein the process generates an uplink resource grant message. A request 98 output from uplink traffic packet parser 94 (see FIG. 3) can trigger a determination that an uplink request has been received. An uplink resource request can also be generated independently from subscriber station 24 in, for example, base station 22, or communication network infrastructure 26, or remote gaming server 34.

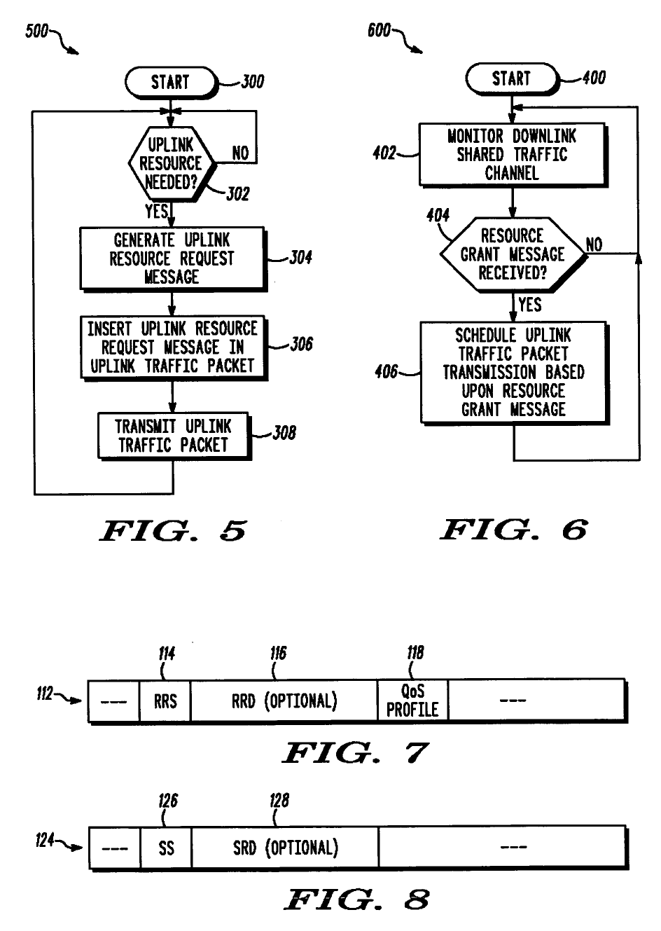

FIG. 8 shows an example of a resource grant message 124 for granting an uplink channel resource to one or more subscriber stations. In one embodiment of the resource grant message, one-bit scheduling status field (SS) 126 can be set to “0” to indicate that there has been no scheduled resource, and therefore other remaining message fields can be omitted. Scheduling status field 126 can be set to “1” to indicate that a scheduled resource description is contained in a following field. Scheduled resource description field (SRD) 128 is used to describe the scheduled communication resources, such as time slots and frequencies (which can also be referred to as sub-carriers), for the subscriber stations that are to be served by an upcoming uplink frame.

Scheduling uplink channel resources in packet scheduler 74 (see FIG. 2) can include allocating time slots and frequencies, as shown in the scheduling chart in FIG. 10. Scheduling chart 140 shows uplink frequencies 142 versus time slots 144, which are both uplink channel resources. Scheduling chart 140 can include additional dimensions for scheduling additional communication resources. The first row 146 represents a first time slot, t₁. In this time slot, subscriber station SS₁ is scheduled to transmit on frequency f₁, SS₂ is scheduled to transmit on frequency f₂, and so on. In the second time slot, t₂ on row 148, subscriber station SS₃ is scheduled to transmit on frequency f₁, subscriber station SS₄ is scheduled for frequency f₂, and so on. Note that frequency assignments for subscriber stations can change because they can be assigned based on signal strength measurements of pilot signals received at the subscriber station, in order to avoid assigning a frequency that is in a fade condition.

After generating the uplink resource grant message, the process inserts the uplink resource grant message into a shared traffic packet, as depicted at block 208. The resource grant message contains scheduling information and communication resource allocation information to control future transmissions on uplink channel resources between subscriber stations and the base station. When a plurality of subscriber stations are receiving the shared traffic package, the uplink resource grant message grants a dedicated resource for each of the plurality of subscriber stations in a multi-user resource grant message. Portions of the multi-user resource grant message can be directly addressed to respective subscriber stations, or alternatively portions may be indirectly addressed by using a mapping function, such as addressing the information to a “first,” “second” or “third” subscriber station.

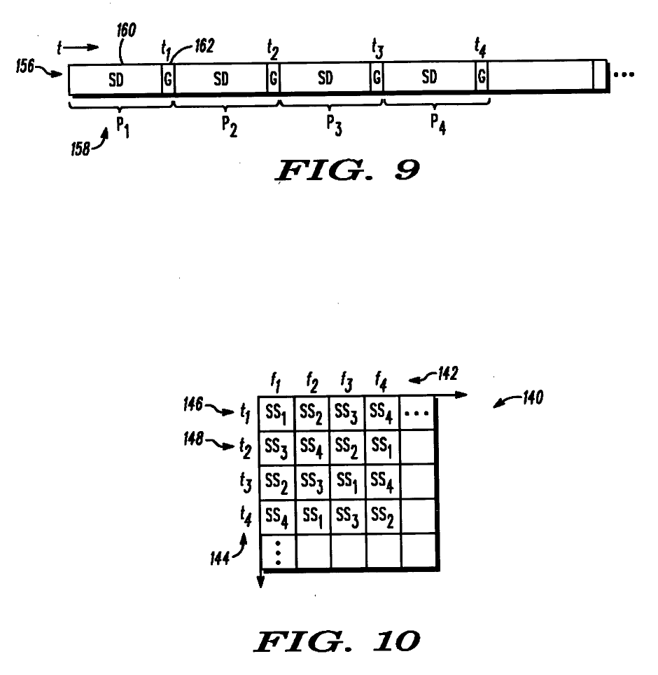

With reference now to FIG. 9, there is depicted a representative diagram of a stream of packets transmitted in a shared traffic channel. Packet stream 156 comprises a series of shared traffic packets 158, labeled P₁-P₄, which are sequentially transmitted. Each traffic packet 158 includes a shared data portion (SD) 160 and a resource grant message portion (G) 162.

When multi-user games are played, shared data portion 160 is used by subscriber stations engaged in game play to display game related data, such as changes in a game environment, or actions or inputs from other game players. Resource grant message 162 is used by the subscriber stations in the game to schedule an upcoming uplink traffic packet transmission of game related data, such as user inputs or other game related action. Resource grant message 162 can contain uplink channel resource scheduling data for some or all of the subscriber stations involved in the game.

After the resource grant message is inserted into the shared traffic packet, the shared traffic packet is transmitted on the shared traffic channel, as illustrated at block 210. After transmitting the shared traffic packet, the process iteratively returns to block 202 to monitor traffic channels for additional resource requests.

Under certain conditions, such as when a subscriber station has not sent an uplink packet in a predetermined time period, the process can periodically transmit an unsolicited resource grant message to give that subscriber unit a scheduled time to send an uplink traffic packet that contains an additional uplink resource request message. This is analogous to periodic polling, which can be needed because uplink requests are sent in uplink packets, and without a recently sent uplink traffic data packet, there will not be an opportunity to send an uplink resource request when the need to send uplink traffic data finally arises.

Turning now to FIG. 5, there is depicted a high-level flowchart 500 of exemplary processes executed by portions of a subscriber station, which is shown in FIGS. 1 and 2. As illustrated, the process begins at block 300, and thereafter passes to block 302 wherein the process determines whether or not an uplink channel resource is needed. When using a game playing application, this determination can be made based on whether or not a subscriber station user has pressed a button or entered other game-related input that needs to be transmitted to the base station. If no uplink resource is needed, the process can iteratively loop until an uplink resource is needed.

When the subscriber station needs an uplink channel resource, the process passes to block 304, wherein the process generates an uplink resource request message. An example of such a message is shown in FIG. 7. The uplink resource request message can include a request for a time slot, a frequency, a spreading code, a quality of service level, or other such communication resources required or permitted by the particular protocol being used to send uplink channel packets.

Next, the process inserts the uplink resource request message in an uplink traffic packet, as illustrated at block 306. The uplink traffic packet includes an uplink data portion that can contain game-related traffic data, and an uplink resource message portion that can contain a request for uplink channel resources. Thus, the request for uplink channel resources is an “in-band” request because it is embedded or formatted within data traffic being sent from the subscriber station to the base station. Note that the uplink resource request message is inserted into a data channel being used for execution or operation of the particular application, rather than a packet for transmission on a dedicated control channel separate from the uplink data traffic channel already in use.

After preparing the uplink traffic packet containing the resource request message, the process transmits the uplink traffic packet on an uplink traffic channel, as depicted in block 308. After transmitting the uplink traffic packet, the process iteratively returns to block 302 to monitor the need for additional uplink resources.

Because there may not be an opportunity to acknowledge the correct receipt of the uplink traffic packet, or because there may not be time to retransmit the uplink traffic packet, the subscriber station can periodically repeat a request for an uplink channel resource to increase the probability that the base station properly receives the request. Additionally, uplink resource request messages can be shortened by setting a bit that indicates a current resource request is the same as a previously received resource request. In this type of repeat-request message, the specific data describing the request can be omitted from the request message. Or if the description of resources requested is present, it is included to ensure accurate transmission, and the data will be ignored if it has already been properly received.

After an uplink channel resource has been requested by a subscriber station, the subscriber station must monitor and respond to messages that grant such communication resources. Therefore, FIG. 6 shows a high-level flowchart 600 of exemplary processes executed by portions of a subscriber station for receiving and responding to resource grant messages. These processes can be executed substantially simultaneously with the processes of FIG. 5. As illustrated, the process begins at block 400, and thereafter passes to block 402 wherein the process monitors the downlink shared traffic channel for resource grant message. In one embodiment, this monitoring process is carried out by resource grant processor 78 in FIG. 2. Resource grant processor 78 examines shared traffic packets 158 (see FIG. 9) for embedded resource grant messages 162. Such resource grant messages 162 can contain dedicated resource grants for a plurality of subscriber stations, which means that each subscriber station must extract a resource grant message addressed to that subscriber station.

Next, the process determines whether or not a resource grant message has been received for the particular subscriber station, as illustrated at block 404. If a grant message intended for the subscriber station has not been received, the process iteratively returns to block 402 to continue monitoring and processing incoming shared traffic packets.

If a resource grant message addressed to the subscriber station has been received, the process schedules an uplink traffic packet transmission based upon the scheduling information in the resource grant message, as depicted in block 406. This scheduling process is carried out in one embodiment by packet scheduler 74 depicted in FIG. 2. Packet scheduler 74 can send instructions to packet generator 72 for generating a subsequent uplink traffic packet. Such instructions can include a packet size, a transmission time slot, a transmission frequency, and instructions related to a quality of service level. Such instructions can be directly or indirectly communicated to transceiver 70 so that transceiver 70 can set particular transmission parameters, such as transmission frequency or spreading codes, in order to comply with the particular communication resource grant message.

After scheduling the uplink traffic packet, the process returns to block 402 to monitor the shared traffic channel for additional resource grant messages. Note that the process depicted in FIGS. 5 and 6 operate substantially simultaneously within one or more processors within the subscriber station.

It will be appreciated that the above described functions and structures can be implemented in one or more integrated circuits. For example, many or all of the functions can be implemented in the signal processing circuitry that is suggested by FIG. 1.

The processes, apparatus, and systems, discussed above, and the inventive principles thereof are intended to and can alleviate scheduling and notification issues caused by prior art techniques. Using these principles of multiple-user in-band request/grant and scheduling, communication resources can be conserved and the performance of applications can be significantly improved with relatively minimal cost.

While the embodiments discussed above primarily relate to playing multi-user games, this scheduling system and processes therein may be used in other multi-user applications, such as applications that share screen data and use inputs from multiple users. For example, the present method and system may be used to implement a shared screen session using the application known as NetMeeting published by Microsoft, Inc.

This disclosure is intended to explain how to fashion and use various embodiments in accordance with the invention rather than to limit the true, intended, and fair scope and spirit thereof. The foregoing description is not intended to be exhaustive or to limit the invention to the precise form disclosed. Modifications or variations are possible in light of the above teachings. The embodiment(s) were chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. A method for scheduling uplink resources for communication with a base station, the method comprising:
receiving an uplink resource request for an uplink channel resource for a subscriber station;
in response to the uplink resource request, generating an uplink resource grant message for scheduling a selected uplink channel resource for the subscriber station; and
inserting the uplink resource grant message into a shared traffic packet for transmission from the base station on a shared traffic channel.

2. The method for scheduling uplink resources according to claim 1 wherein:
the receiving an uplink resource request comprises receiving a plurality of uplink resource requests, wherein each of the plurality of uplink resource requests is for a corresponding uplink channel resource for one of a plurality of subscriber stations;
the generating an uplink channel resource grant message comprises generating a multi-user uplink resource grant message for scheduling a selected uplink channel resource for one or more of the plurality of subscriber stations; and
the inserting the uplink resource grant message comprises inserting the multi-user uplink resource grant message into the shared traffic packet for transmission from the base station on the shared traffic channel.

3. The method for scheduling uplink resources according to claim 2 wherein the receiving a plurality of uplink resource requests comprises receiving the plurality of uplink resource requests in a plurality of uplink traffic channel resources between each of the plurality of subscriber stations and the base station.

4. The method for scheduling uplink resources according to claim 3 wherein the receiving a plurality of uplink resource requests comprises receiving the plurality of uplink resource requests in an in-band field of each of the plurality of uplink traffic channel resources between the plurality of subscriber stations and the base station.

5. The method for scheduling uplink resources according to claim 2 wherein the inserting the uplink resource grant message comprises inserting the uplink resource grant message into a scheduled resource description field of the shared traffic packet.

6. The method for scheduling uplink resources according to claim 5 wherein the inserting the uplink resource grant message comprises inserting the uplink resource grant message into the scheduled resource description field of the shared traffic packet, wherein the scheduled resource description field includes data describing time slots and frequencies scheduled for one or more of the plurality of subscriber stations.

7. A scheduling system for scheduling uplink channel resources for communication with a base station comprising:
an uplink resource scheduler for receiving an uplink resource request for an uplink channel resource for a subscriber station;
a message generator, coupled to the uplink resource scheduler, for generating a resource grant message in response to the uplink resource request, wherein the resource grant message includes data for granting access to a scheduled uplink channel resource to a subscriber station; and
a channel packet generator, coupled to the message generator, for inserting the resource grant message into a shared traffic packet for transmission from the base station on a shared traffic channel.

8. The scheduling system according to claim 7 wherein:
the uplink resource scheduler comprises an uplink resource scheduler for receiving a plurality of uplink resource requests for uplink channel resources, wherein each uplink resource request is from one of a plurality of subscriber stations; and
wherein the message generator comprises a message generator for generating a multi-user resource grant message that includes data for granting access to scheduled uplink channel resources to a portion of the plurality of subscriber stations.

9. The scheduling system according to claim 8 wherein the uplink resource scheduler for receiving a plurality of uplink resource requests for uplink channel resources comprises an uplink resource scheduler for receiving, in uplink traffic packets from the plurality of subscriber stations, the plurality of uplink resource requests for uplink channel resources.

10. The scheduling system according to claim 7 wherein the multi-user resource grant message comprises data for granting, to selected ones of the plurality subscriber units, a scheduled time slot and frequency for sending an uplink traffic packet.

11. The scheduling system according to claim 7 wherein the multi-user resource grant message comprises data for granting, to selected ones of the plurality subscriber units, an uplink channel resource having a quality of service level.

12. A scheduling system for scheduling uplink resources for communication with a base station comprising:
a transceiver;
a resource requester for generating an uplink resource request message for a grant of an uplink channel resource;
a packet generator, coupled to the uplink resource requester and the transceiver, for inserting the uplink resource request message into an uplink traffic packet for transmission to the base station; and
a resource grant processor for receiving a resource grant message in a shared traffic channel packet transmitted on a shared traffic channel.

13. The scheduling system according to claim 12 wherein the packet generator comprises a packet generator for generating an uplink traffic packet having uplink traffic data and an uplink resource request field containing the uplink resource request message.

14. The scheduling system according to claim 13 wherein the uplink resource request message comprises a request for an uplink time slot and frequency.

15. The scheduling system according to claim 13 wherein the uplink resource request message represents a request for an uplink resource having a requested quality of service level.

16. The scheduling system according to claim 13 wherein the uplink resource request message is a repeated request for an uplink channel resource.

17. The scheduling system according to claim 12 wherein the resource grant processor comprises a multi-user resource grant message processor for selecting one of a plurality of resource grants in a multi-user resource grant message in the shared traffic channel.

18. The scheduling system according to claim 17 wherein the multi-user resource grant message includes data for granting a time slot and a frequency to a portion of the plurality of subscriber stations.

19. The scheduling system according to claim 17 wherein the multi-user resource grant message includes data for granting an uplink channel resource having a quality of service level.

20. The scheduling system according to claim 17 wherein the multi-user resource grant message includes a repeated multi-user resource grant message.
